(19) United States
(12) Patent Application Publication
(10) Pub. No.: US 2002/0071546 A1
(43) Pub. Date: Jun. 13, 2002

(54) Method, device and software for processing incoming communications

(75) Inventor: Paul M. Brennan, Toronto (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/733,061

(22) Filed: Dec. 11, 2000

(51) Int. Cl. H04M 11/00; G06F 15/16; H04M 1/00; H04M 3/00

(52) U.S. Cl. 379/379; 379/93.24; 709/207

(57) ABSTRACT

Methods, devices and software for processing incoming communications are disclosed. Incoming messages and calls may be prioritized in accordance with the rank of the message or call originator within the organization. This may be effected by querying an org chart for the organization upon receipt of an incoming communication, in order to assess the rank of the originator. The org chart may be stored in a directory server, and queried by a computing device receiving the message or processing the call. The methods lend themselves to processing received electronic mail messages, telephone calls and the like. In an example embodiment, calls from originators meeting defined criteria may initiate distinctive ringing at the recipient's phone or may signal another device.

### FIELD OF THE INVENTION

The present invention relates to communication processing and more particularly to a method, device and software for prioritizing incoming communications including electronic messages and calls.

### BACKGROUND OF THE INVENTION

In recent years, electronic mail (e-mail) has become a favored form of communication. With the growth of the public internet, the popularity and reliance upon e-mail has exceeded that of facsimiles. This form of communication has become so popular that the volume received e-mail messages is overwhelming for many recipients. Undoubtedly this problem will become more pronounced as e-mail systems are integrated with other traditional messaging systems, such as voice messaging systems.

In order to effectively manage large volumes of e-mail, modern e-mail messaging software applications allow e-mail originators to originate messages marked with priority information. E-mail originators, however, typically associate priorities with their messages that are not shared by recipients. Moreover, in the presence of many messages having the same priority the priority information still does not assist the recipient.

Other e-mail messaging application allow recipients to filter e-mail messages based on user defined rules. For example, U.S. Pat. No. 6,057,841 describes an e-mail application that allows messages to be sorted based on user defined rules. These rules may cause the e-mail client to examine attributes of incoming e-mails and sort the e-mails based on these attributes. This technique is effective for messages whose attributes are known. However, when e-mail that does not fit a defined pattern is received, user-defined rule based handling may not be adequate.

Similarly, the volume of incoming telephone calls and other communications has also increased in recent years. As such, many incoming live telephone calls are often forwarded to voice messaging systems, regardless of their importance. Voice mail messages, once stored are similarly typically not sorted based on their relative priority to the recipient. Other communications are similarly handled, regardless of their importance.

Accordingly, improved methods, software and devices for processing communications to facilitate prioritizing of such communications are desirable.

### SUMMARY OF THE INVENTION

In accordance with the present invention an incoming communication may be processed in accordance with the rank of the originator of the communication within an organization. This may be effected by querying an org chart for the organization in order to assess the rank of the originator.

In accordance with an aspect of the invention, a computer implemented method of processing incoming communications includes receiving an associated indicator of a position of an originator of said each of the communications within an organization for each of the incoming communications; and processing each of the communications based on its associated indicator.

In accordance with another aspect of the invention, a computing device includes a processor, operable to process incoming communications by receiving an associated indicator of a position of an originator of each communication within an organization; and process each communication based on its associated indicator.

In accordance with a further aspect of the invention, a computer implemented method of prioritizing received electronic messages for a recipient associated within an organization, includes: for each of the electronic messages, receiving an associated indicator of a position of an originator of the electronic message within the organization; for each of the electronic messages, using the associated indicator to determine a relative rank of said originator within the organization; and sorting the electronic messages based on the relative rank associated with each of the messages.

In accordance with yet another aspect of the invention, a computer readable medium stores computer executable instructions that when loaded at a computing device adapt the computing device to receive an indicator of a position within an organization of an originator of an incoming communication; and process this incoming communication based on the indicator.

Other aspects and features of the present invention will become apparent to those of ordinary skill in the art, upon review of the following description of specific embodiments of the invention in conjunction with the accompanying figures.

### BRIEF DESCRIPTION OF THE DRAWINGS

In figures which illustrate, by way of example only, preferred embodiments of the invention,

FIG. 1 illustrates a computing device exemplary of an embodiment of the present invention, in communication with a data network;

FIG. 2 schematically illustrates the architecture of the exemplary computing device of FIG. 1;

FIG. 3 illustrates the organization of memory of the device of FIG. 1;

FIG. 4 illustrates an exemplary organization of received messages at the device of FIG. 1;

FIG. 5 illustrates an exemplary organization of a directory structure stored within a directory server of FIG. 1;

FIG. 6 illustrates an organizational chart for exemplary records within the directory of FIG. 5;

FIG. 7 is a flow chart illustrating steps performed by the exemplary computing device of FIG. 1;

FIG. 8 illustrates a display of summary information about received messages at the device of FIG. 1;

FIG. 9 illustrates a further computing device exemplary of another embodiment of the present invention, in communication with a data network and a telephone network; and

FIG. 10 is a flow chart illustrating steps performed by the exemplary computing device of FIG. 9.

### DETAILED DESCRIPTION

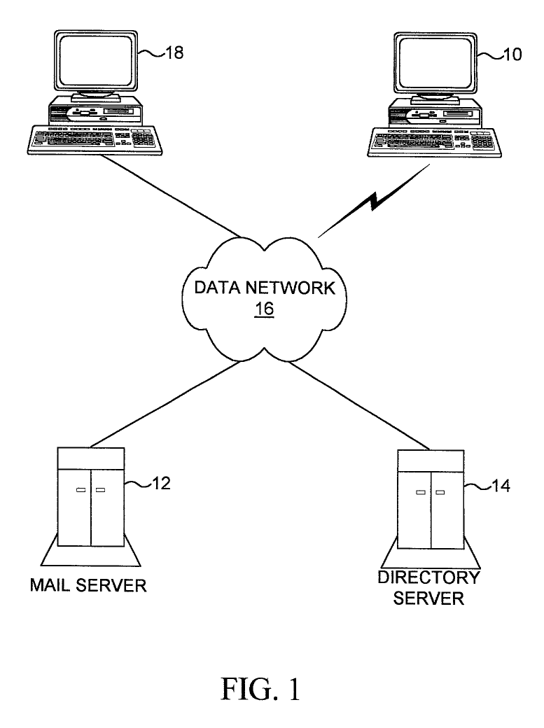

FIG. 1 illustrates a computing device 10, exemplary of an embodiment of the present invention. Computing device 10 is in communication with an electronic mail server 12 and a directory server 14. Mail server 12 and directory server 14 are in communication with a data network 16. Device 10 may be in communication with server 12 and directory server 14 by way of data network 16, or by way of one or more other communication networks (not shown). An additional general purpose computing device 18 interconnected with network 16, is also illustrated.

Example network 16 is preferably a packet switched communications network that allows interconnected computing devices to exchange data using known packet based protocols, such as the internet protocol (“IP”), as detailed in RFC 791. Network 16 may for example be the public internet or a private intranet.

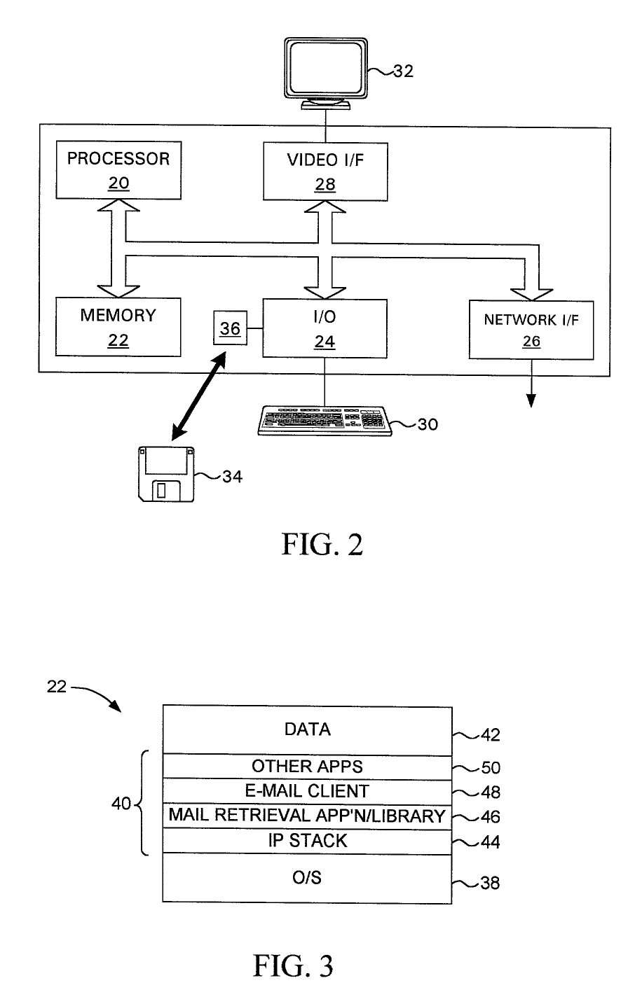

A simplified preferred architecture of device 10 is schematically illustrated in FIG. 2. In the illustrated embodiment, device 10 is a conventional network capable workstation. Device 10 could, for example, be an Intel x86 based computer acting as a Microsoft Windows NT, Windows 2000, Apple, or Unix based workstation, personal computer or the like.

Device 10 includes a processor 20, in communication with computer readable memory 22; network interface 26; input output interface 24; and video adapter 28. As well, device 10 may include a display 32 interconnected with adapter 28; input/output devices, such as a keyboard 30 and disk drive 36 and a mouse (not shown) or the like. Processor 20 is typically a conventional central processing unit, and may for example be a microprocessor in the INTEL x86 family. Of course, processor 20 could be any other suitable processor known to those skilled in the art. Computer storage memory 22 includes a suitable combination of random access memory, read-only-memory, and disk storage memory used by device 10 to store and execute software programs adapting device 10 to exchange messages using network 16, and manage received messages in manners exemplary of the present invention. Drive 36 is capable of reading and writing data to or from a computer readable medium 34 used to store software and data to be loaded into memory 22. Computer readable medium 34 may be a CD-ROM, diskette, tape, ROM-Cartridge or the like. Network interface 26 is any interface suitable to physically link device 10 to network 16. Interface 26 may, for example, be an Ethernet, ATM, ISDN interface or modem that may be used to pass data from and to network 16 or another suitable communications network.

An exemplary organization of computer storage memory 22 of device 10 is illustrated in FIG. 3. As illustrated, stored within memory 22 are computer software programs and data that are used by processor 20 to permit device 10 to be operable as network communication capable device. As illustrated, memory 22 stores operating system software 38; application software 40; and data within data portion 42. Operating system software 38 may, for example, be Microsoft Windows NT Workstation operating system software, Microsoft Windows 3.1, 95, 98 or CE software, Apple Macintosh System 7.5 software, UNIX operating system software, or the like. Application software 40 includes network interface software 44 which typically includes an internet protocol stack allowing communication of device 10 and thus operating system 38 with network 16 (FIG. 1), through physical network interface 26 (FIG. 2). Application software 40 further includes a message retrieval application/library 46 and message handling client software 48. Other applications 50 used by an end-user at device 10 may also be stored within memory 18. Data within data portion 42 may be stored, processed and retrieved by processor 20 under control of applications 40 or operating system 38.

As understood by those skilled in the art, network interface software 44 may include internet stack that supports the basic internet protocol as detailed in RFC 791, TCP/IP and other internet protocols. Interface software 44 enables device 10 to exchange data over network 12 using known IP protocols, including messages that may be in the form of e-mail messages in the simple mail transfer protocol (SMTP). Suitable internet stacks are readily available for various platforms, and may form part of operating system 38.

Personal message handling application 48 adapts device 10 to function in manners exemplary of the present invention. Message handling application 48, in its simplest form, may be a conventional e-mail handling application suitably modified. Example conventional e-mail applications that may readily be modified to functions exemplary of the present invention include UNIX based e-mail clients such as Pine or Elm; Microsoft Windows based clients Eudora (by Qualcomm); Microsoft Exchange or Microsoft Outlook, or other similar applications known to those of ordinary skill. The message handling application 48 receives data representative of e-mail messages retrieved by message retrieval application 46. Message retrieval application 46 is preferably a conventional SMTP mail transfer application or library, and may for example, be a UNIX based Fetchmail application, the Microsoft Windows Messaging Application Programming interface, or a similar program or library. In any event, mail retrieval application 46 enables device 10 to retrieve mail messages from remote mail server 12 (FIG. 1), by way of network 16. Mail retrieval application 46 preferably supports available remote-mail protocols such as POP and the IMAP protocols.

As will become apparent, message handling application 48 may additionally retrieve internet directory information by way of network 16 from example directory server 14.

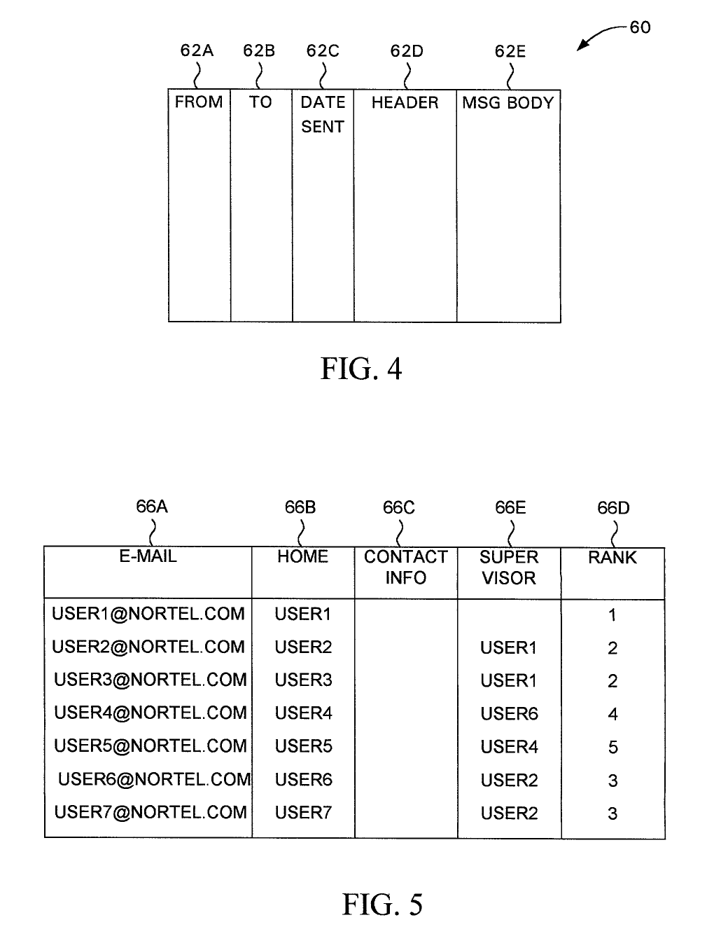

An exemplary format of data stored within data portion 42 of memory 22 by message handling application 48 is illustrated in FIG. 4. As illustrated, handling application 48 stores received e-mail messages within data portion 42 of memory 22. The messages may be stored as single text file; as part of a relational database; or hierarchically as, for example, detailed in U.S. Pat. No. 6,057,841, or otherwise. As illustrated in FIG. 4, received message may be parsed and stored as records in a relational database table 60. Each record includes fields 62a, 62b, 62c, 62e representing the e-mail originators address in field 62a; recipient's address in field 62b; date sent in field 62c; full SMTP message header in field 62d; and message body in field 62e.

Directory server 14 is also a network capable server computing device in communication with data network 16. The architecture of server 14 is not specifically illustrated as it will be readily appreciated by a person of ordinary skill. Server 14 stores and executes an operating system, internet protocol stack and a directory services application such as an lightweight directory access protocol (LDAP) or X.500 compliant application, modified to store organizational directory information as detailed below. An exemplary directory is also stored within memory of directory server 14. Records in an example directory are partially illustrated in FIG. 5. As illustrated, each record preferably includes the name, e-mail address, contact information (including phone number) and organizational information, in fields 66a, 66b, 66c and 66d, respectively. Directory services application at directory server 14 provides suitable responses to directory queries, providing the contents of all fields for queried records.

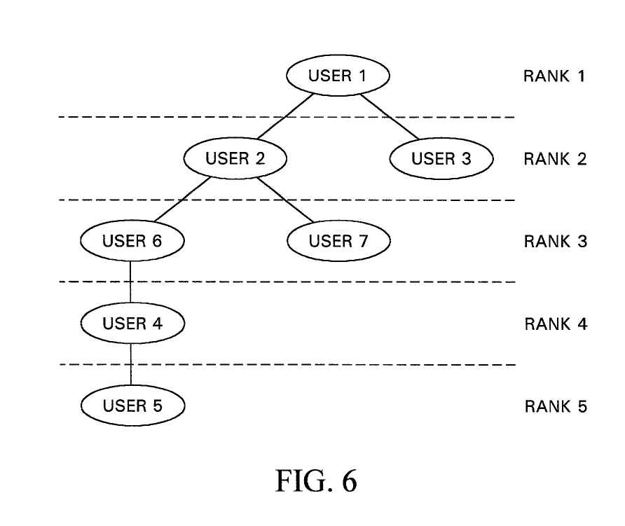

As illustrated field 66d represents the organizational level of an e-mail recipient within a particular organization. Further, field 66e contains the name of the supervisor of the recipient. Preferably the contents of field 66d reflects a numerical value of the hierarchical position of the individual within the organization, and thereby explicitly identifies the position of the originator within the organization. In the illustrated embodiment, displayed fields 66d and 66e reflect an organizational structure as illustrated in FIG. 6. As a result, an entry in field 66e having a value of 1 represents an individual at the top of an organization, while individuals having a value of 2 are second in rank, and so on. An existing LDAP database, may for example be modified to include suitable attributes to add fields 66d and 66e.

Optionally, field 66c includes telephone calling number identification information associated (CLID) with a particular e-mail originator. As will become apparent this CLID information may be used to determine the hierarchical position of a telephone caller.

A person of ordinary skill in the art will, of course, appreciate that any suitably database server storing rank information may be used as server 14.

Message server 12 (FIG. 1) is similarly not described in detail. It may be formed using any conventional mail server that conforms to a known e-mail delivery protocol. Server 12 may, for example, be a UNIX or Microsoft NT based computing device storing and executing an e-mail server application, such as Microsoft Exchange Server, or the like. The server may act as a post-office-protocol (“POP”) compliant server as detailed in IETF RFCs 1725, 1734 and 1939, or an IMAP compliant server, as for example detailed in RFC 2060.

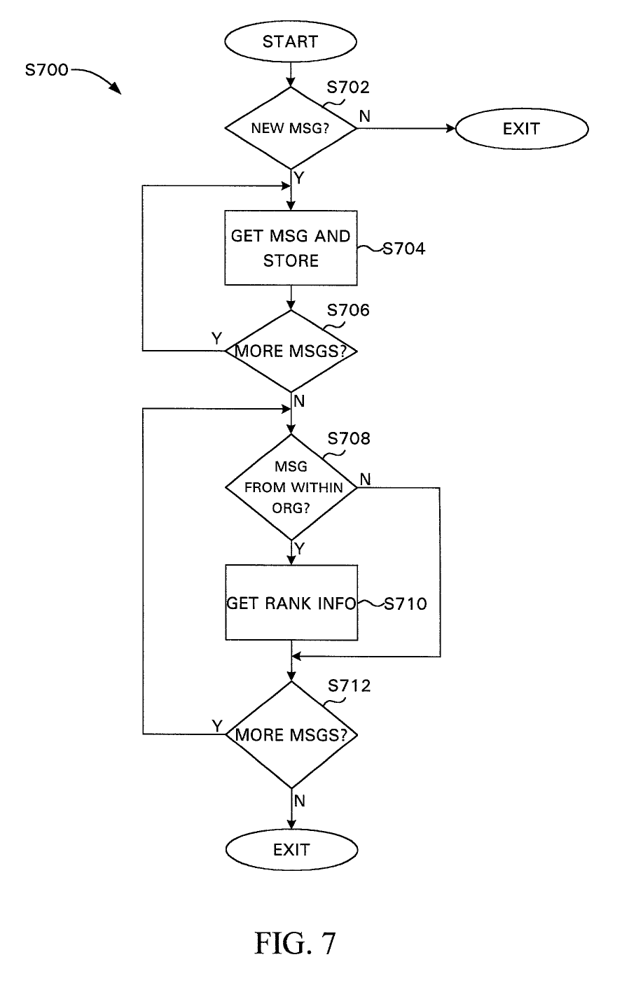

In operation, an e-mail originator dispatches e-mails for recipient at device 10. The originator may use example computing device 18, or any other suitable device in communication with network 16. In a conventional manner, based on a dispatched e-mail's destination address, the e-mail message is sent to mail server 12, for eventual retrieval by computing device 10. Computing device 10 under control of message handling application 48 and mail retrieval application 46 periodically executes steps S700 illustrated in FIG. 7, in order to retrieve and organize e-mails destined for a recipient at device 10 and stored at mail server 12. As illustrated, mail retrieval application contacts server 12 and checks for new messages in step S702. If new messages are stored at server 12, they are retrieved in steps S704-S706, parsed, and stored within table 60 (FIG. 4) of data portion 42 of memory 22. After messages have been retrieved, device 10 under control of message handling application 48 contacts directory server 14 in order to obtain hierarchical information for each e-mail originator. Specifically, device 10 provides to directory server 14 the e-mail address of the e-mail originator for each newly received e-mail, for which hierarchical information is sought in step S710. Communication between directory server 14 and device 10 may be effected using the conventional protocols, such as the LDAP protocol. So that the rank information for the individual is meaningful, device 10 preferably only obtains hierarchical information for e-mails originating within the same organization as that associated with device 10, as determined in step S708. This may be effected by only querying directory server 14 for e-mails having an originator's (return) address with a domain identical to the recipient's at device 10. In any event, the hierarchical information as stored in field 66d is retrieved from directory server 14 and associated with each received e-mail and stored within memory 22. Of course, in the event that an individual has dealings with multiple organizations, the server, or multiple servers, may be queried for e-mails having an originator's (return) address associated with any of the multiple organizations.

Optionally, message handling application 48 may additionally traverse the organizational hierarchy by querying directory server 14 for information about a message originator's immediate supervisor, as for example stored in field 66d. Similarly, message handling application 48 may query information about the supervisor's supervisor, and so on. Queried information may be stored within memory 22, optionally within an additional field (not shown) of table 60. Message handling application 48 may construct a hierarchical view of the originator's role within the organization, within memory 22. If desired, message handling application 48 may display the hierarchical information graphically as illustrated in FIG. 6. Conveniently, message handling application 48 may also determine if the originator reports to others in the direct chain of authority within the organization (i.e. the same branch of the organization) as the recipient and thus ultimately reports to the same supervisor as the recipient.

As a further alternative, message handling application 48 may calculate the total distance within the organizational hierarchy between a supervisor common to the originator and recipient. Each link between the originator and recipient may add a value of one (1) to this distance measure. Thus, for example, the distance between the supervisor common to user5 and user3 in FIG. 6 might be calculated as 4 and 1, suggesting that messages from user5 to user3 should not be treated with high priority. A variety of other metrics indicative of the originator's significance and relationship to the recipient could easily be calculated in order to prioritize the incoming messages.

Alternatively, server 14 may store an alpha-numeric identifier of an originator's rank. For example, each record may include an individual's title in the organization. Message handling application 48 could in turn query the alphanumeric identifier of rank, and use it to indicate rank, for processing as described above.

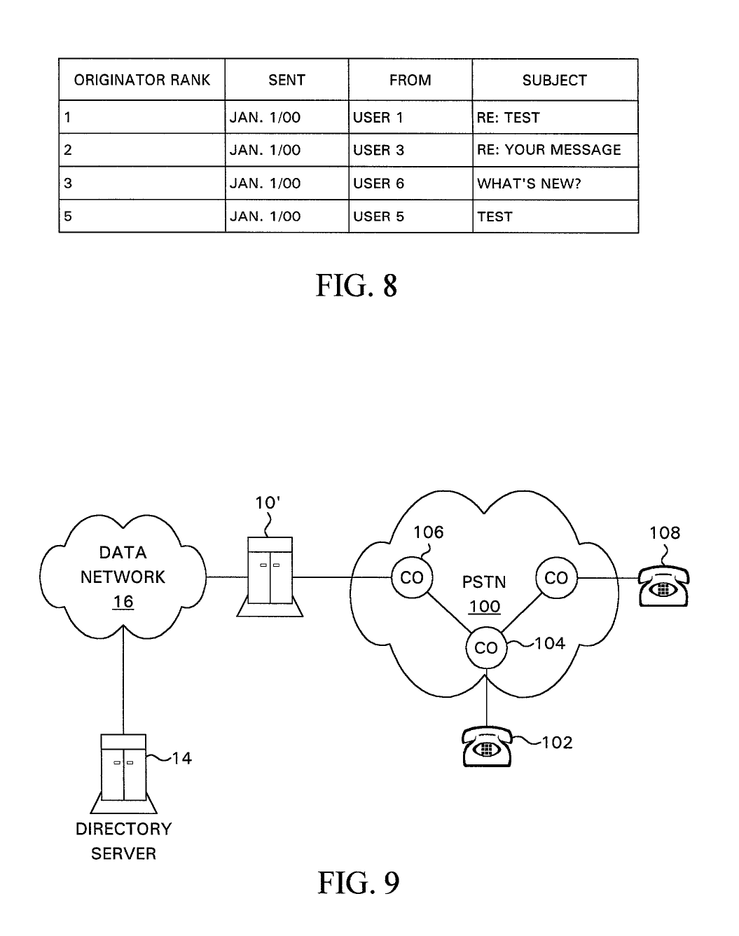

Message handling application 48 may then display received e-mails, as illustrated in FIG. 8. Preferably, message handling application 48 may sort displayed e-mails based on the value of any displayed field (i.e. column). Of course, the exact order and format for each field may be user configured. Conveniently, message handling application 48 allows incoming messages to be sorted based on the organizational rank/metric associated with the originator of each message. Thus, the recipient may now prioritize received e-mails based on the rank of the originator. For e-mails that originate outside of the recipient's organization, no rank information need be stored or displayed. Thus, external e-mails may be displayed above or below internal e-mails, having rank information.

While device 10 has been illustrated as a network capable workstation, the described invention could be embodied in any suitable device having computing capability that may be adapted to function in manners exemplary of the present invention. The invention could, for example, be embodied in a portable computing device in communication with mail server 12 and directory server 14 by way of a wireless network. Such a device may for example be a portable “laptop” computer; a personal digital assistant; or a personal communications device such as a cellular telephone. A person of ordinary skill will readily recognize many similar devices that may suitably embody the present invention.

As should now also be appreciated, although the described embodiment has been described in the context of received e-mail messages the invention could easily be used to process a wide variety of incoming communications, including e-mails, voice-mail messages, multimedia messages, real time messages, other messages, or real-time communications, including for example real-time Internet messages.

Accordingly, FIG. 9 illustrates a further embodiment of the present invention. In this embodiment computing device 10′ is in communication with directory server 14 and the public switched telephone network (PSTN) 100. Device 10′ is similar to device 10. However, instead of, or in addition to the described e-mail application, device 10′ further includes telephone call handling software. A device suitable for modification to be used as device 10′ is, for example, described in U.S. Pat. No. 5,329,578, the contents of which are hereby incorporated by reference. Alternatively, device 10′ could store and execute Call Pilot software, available from Nortel Networks, but modified to function in a manner exemplary of the present invention. Specifically, device 10′ receives indicators of incoming telephone calls destined for telephone 102. These indicators may, for example, be forwarded by PSTN central office 104 associated with telephone 102. Signaling information could be provided as SS7 or ISDN signaling information by way of a central office 106, in communication with device 10′. As such, device 10′ also includes a suitable interface to receive appropriated signaling information from PSTN 100. Signaling interface preferably receives an indicator of the incoming call and calling party information (CLID).

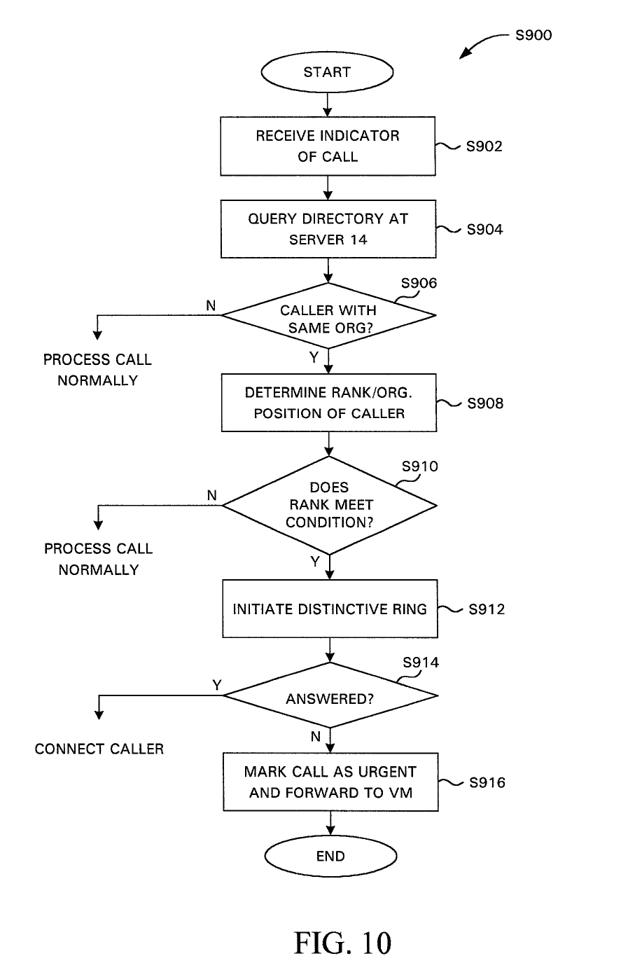

Software exemplary of another embodiment of the present invention, executing at device 10′, assesses the priority of an incoming call in accordance with steps S900 of FIG. 10. Specifically, upon receipt of an indicator of an incoming call in step S902, device 10′ queries directory server 14 (FIG. 8) using the CLID information to determine if the incoming call originates with an individual in the same organization as the call recipient associated with telephone 102 in step S904-S906. If so, device 10′ determines the position of the caller within the organizational hierarchy of call originator and recipient in step S908. In the event the relationship of the caller and recipient meets a pre-defined relationship, as determined in step S910 the incoming call may be flagged as urgent and processed in accordance with special handling rules. For example, if the originator has a rank within the organization that is higher than the rank of the recipient, a distinctive ring may be sounded at phone 102 in step S912. U.S. patent application Ser. No. 09/609,295, for example, discloses methods and devices for generating a distinctive ring indicative of urgency of an incoming call that may be used in conjunction with or as part of device 10′. Alternatively, if the caller has a low rank, the call may be forwarded directly to a voice mail system without causing a phone to ring. Similarly, rank information could be used in combination with other call processing features, as detailed in U.S. Pat. No. 5,329,578. Additionally, or alternatively, if the call is forwarded to a voice messaging system as determine in step S914, a priority or urgency flag may be associated with the call in steps S916 so that it may be heard prior to voice messages having no priority. Systems using the Call Pilot software, for example, allow incoming voice messages to be sorted in an appropriate order based on associated urgency indicators. Alternatively, the call could be signaled at a further device in communication with telephone network, such as telephone 108, a pager, or another network appliance (not illustrated).

As will now be appreciated, device 10′ could form part of a private branch exchange, a central office or cellular base station, or as part of an enhanced telephone device, such as a cellular handset or desktop telephone.

As will further be appreciated, directory server 14 could be in communication with device 10 or 10′, by way of a local area network, and need not be connected with a public network such as network 16. Moreover, the contents and function of directory server 14 could be co-located or integrated with device 10 or device 10′, thereby eliminating the need for a network link between device 10 or device 10′ and directory server 14. Alternatively, rank information for an originator of a message could be included in the message, in for example, an e-mail header.

Moreover, although the function of device 10 has been isolated from the function of mail server 12, a person skilled in the art will readily appreciate that many features of the invention could be embodied in mail server 12. As such, mail server 12 could obtain priority information from directory server 14 before messages are retrieved by device 10. Similarly, mail server 12 could dispatch notifications or the like to other devices by way of network 16 or any other network in communication with server 12. For example, server 10 could dispatch notification of incoming e-mails from originators of a sufficient rank, to pagers or other devices before or without notifying the recipient device 10.

Additionally, while the organization of hardware and software functional blocks, have been illustrated as clearly delineated, a person skilled in the art will appreciate that the delineation between blocks is somewhat arbitrary. Numerous other arrangements of hardware and software blocks are possible.

The above described embodiments are intended to be illustrative only and in no way limiting. The described embodiments are susceptible to many modifications of form, arrangement of parts, and details and order of operation. The invention, rather, is intended to encompass all such modification within its scope, as defined by the claims.

What is claimed is:

1. A computer implemented method of processing incoming communications, comprising:
for each of said communications, receiving an associated indicator of a position of an originator of said each of said communications within an organization; and
processing each of said communications based on its associated indicator.

2. The method of claim 1, wherein each of said communications comprises an electronic message.

3. The method of claim 2, wherein said processing comprises sorting said communications using said associated indicator for each of said communications.

4. The method of claim 2, wherein said associated indicator for each of said communications is retrieved from a directory server.

5. The method of claim 2, wherein each indicator comprises a rank of an originator of said communication with which said indicator is associated.

6. The method of claim 2, wherein each of said communications includes said associated indicator, associated therewith.

7. The method of claim 4, further comprising receiving said electronic messages from a message server.

8. The method of claim 3, further comprising displaying summary information for each of said communications, said summary information ordered based on said sorting.

9. The method of claim 5, wherein said indicator for each of said communications comprises a numerical value representative of an originator's rank within an org chart for said organization.

10. The method of claim 1, wherein each of said communications comprises one of a voice-mail message, a multimedia message, and a real-time communication.

11. A computing device including a processor, operable to process incoming communications by
receiving for each of said communications an associated indicator of a position of an originator of said communication within an organization; and
processing each of said communications based on its associated indicator.

12. A computer implemented method of prioritizing received electronic messages for a recipient associated within an organization, comprising:
for each of said electronic messages, receiving an associated indicator of a position of an originator of said each electronic message within said organization;
for each of said electronic messages, using said associated indicator to determine a relative rank of said originator within said organization;
sorting said electronic messages based on said relative rank associated with each of said messages.

13. A call handling device in communication with a telephone network, said call handling device comprising a processor and a telephone network interface, said processor operable to
receive an indicator of an incoming call for a particular recipient, by way of said telephone network interface;
determine an indicator of a position of an originator of said incoming call within an organization; and
process said call based on said indicator.

14. The device of claim 13, wherein said processor is operable to initiate a distinctive ring at a telephone of said particular recipient, in response to determining said originator of said incoming call has a position above said recipient in an org chart for said organization.

15. The device of claim 13, wherein said processor is operable to initiate provision of priority information to a voice messaging system receiving said incoming call.

16. The device of claim 13, wherein said processor is operable to query a directory for said organization in order to determine said indicator.

17. The device of claim 13, wherein said processor is operable to signal a second device in communication with said telephone network.

18. The device of claim 17, wherein said second device comprises a pager.

19. A computer readable medium, storing computer executable instructions that when loaded at a computing device adapt said computing device to:
receive an indicator of a position within an organization of an originator of an incoming communication; and
process said incoming communication based on said indicator.
